(19) United States
(12) Patent Application Publication
(10) Pub. No.: US 2007/0064760 A1
(43) Pub. Date: Mar. 22, 2007

(54) Optical amplification in miniaturized polymer cavity resonators

(76) Inventor: Soren Kragh, Copenhagen (DK)

Correspondence Address: KNOBBE MARTENS OLSON & BEAR LLP, 2040 MAIN STREET, FOURTEENTH FLOOR, IRVINE, CA, 92614, US

(21) Appl. No.: 10/560,093

(22) PCT Filed: Jun. 10, 2004
(86) PCT No.: PCT/DK04/00395

§ 371 Date: Oct. 2, 2006

(30) Foreign Application Priority Data
Jun. 12, 2003 (DK) PA200300874
Jun. 12, 2003 (US) 60/477791

(51) Int. Cl. H01S 3/08

(52) U.S. Cl. 372/92; 427/162

(57) ABSTRACT

An optical device for providing optical amplification comprises a substrate, a radiation sensitive polymer structure provided on the substrate in a shape defined by a number of sidewalls, n, and being doped with an optically active medium, wherein the sidewalls of the structure form a cavity resonator so that an electromagnetic wave upon pumping of the device is emitted laterally. The radiation sensitive polymer may be a photo-definable polymer, such as SU-8. The optical device for providing optical amplification may also comprise a substrate and a photo-definable polymer structure provided and being doped with an optically active medium. The device may have a shape and/or at least one material provided at least along a part of at least one sidewall of the structure so that a beam propagating in the structure will experience total internal reflection when incident on no more than n-1 sidewalls.

### FIELD OF INVENTION

The present invention relates to a miniaturized solid state cavity resonator based on a polymer such as a radiation sensitive polymer, such as a photo-definable polymer. Optical amplification is provided by doping the polymer with an optically active medium, such as a laser dye. A solid state laser is manufactured by doping the polymer with a laser dye and by using the radiation sensitivity of the material to form a resonator cavity laser is provided.

### BACKGROUND OF THE INVENTION

It is known in the art of MEMS, Micro Electro Mechanical systems, and of “Lab-on-a-chip” systems to combine various components, such as waveguides, flow channels, optical detectors etc. on a single chip. However, it is often a problem to couple light used for e.g. analysis into and out of these microsytems. Typically, a fiber is used for transmitting light from a light source onto the microsystem. However, in order to couple the light into optical components positioned on the chip, careful alignment of chip and fiber is essential, thus making the assemble sensitive to any external impacts. Furthermore, many of the Lab-on-a-chip systems would be suitable for use with single use devices, provided that a cheap light source could be provided on the chip itself.

The functionality of such microsystems may thus be enhanced by integration of optical transducers, such as e.g. solid state lasers, on the chip. Polymer based solid state lasers are attractive devices for such applications, since polymer based micro-chips integrating polymer waveguides, polymer flow channels, etc. are already widely used for lab-on-a-chip microsystems.

Hu et al. (Thin-film dye laser with etched cavity, C. Hu and S. Kim, Appl. Phys. Lett., Vol. 29, page 582 (1976)) has demonstrated a millimeter-sized solid state dye laser by casting a commercially available laser dye into a matrix of polyurethane. The dye doped polyurethane is filled into an etched silicon cavity being coated with a thin layer of SiO₂ or metal, thus forming a Fabry-Perot cavity. The laser light is coupled into a waveguide grown on top of the laser cavity.

Li et al. (Fabrication and testing of solid polymer dye microcavity lasers based on PMMA micromolding, Y. Li, M. Sasaki, and K. Hane, J. Micromech. Microeng. Vol. 11, page 234, (2001)) has made a similar device using modern microfabrication techniques for making similar devices in poly-methymethacrylate (PMMA) by casting the cavity in a silicon mold and peel-off of the molded laser cavities. The cavity uses the principle of total internal reflection and the laser light is coupled out through the surface of the cavity.

However, none of these references provide a resonator cavity being easy to manufacture without the use of silicon molds, and furthermore being capable of emitting light laterally, so as to e.g. facilitate coupling of light into a waveguide positioned in the same plane as the resonator cavity and still further which may be provided on any substrate material.

### DETAILED DESCRIPTION

It is an object of the present invention to provide a resonator cavity being simple to manufacture to e.g. make the cavities suitable for single use devices.

It is a further object of the present invention to provide a resonator cavity in a photo-definable polymer, such as a photo-resist material, such as SU-8.

It is another object of the present invention to provide a resonator cavity which may be provided on any substrate material.

It is a still further object of the present invention to provide a resonator cavity being capable of lateral emission.

According to a first aspect of the present invention, the above and other objects are fulfilled by an optical device for providing optical amplification, wherein the optical device comprises

a substrate, and

a radiation sensitive polymer structure provided on the substrate in a predetermined shape defined by a number of sidewalls, n, and being doped with an optically active medium, wherein the sidewalls of the structure form a cavity resonator so that an electromagnetic wave upon pumping of the device is emitted laterally.

According to a second aspect of the present invention, the above and other objects are fulfilled by an optical device for providing optical amplification, wherein the device comprises

a substrate, and

a radiation sensitive polymer structure provided on the substrate in a predetermined shape defined by a number of sidewalls, n, and being doped with an optically active medium, wherein the shape and/or at least one material provided at least along a part of at least one sidewall of the structure are selected so that an electromagnetic wave propagating in the structure will experience total internal reflection when incident on no more than n-1 sidewalls.

It is an advantage that the polymer structure may be provided on any substrate material, and that the substrate do not necessarily have to be plagiarised before the polymer structure is formed on the substrate. Thus, other structures, such as waveguides, micro channels, etc, may be formed on the substrate using another or the same material platform before the polymer structure is formed on the substrate. Alternatively, these other structures may be formed after the polymer structure has been formed.

An electromagnetic wave may be emitted from at least a part of at least one sidewall of the structure upon pumping of the device.

The electromagnetic wave propagating in the structure, for example in response to any pumping of the device, may be incident at the no more than n-1 sidewalls at an angle greater than a critical angle to obtain total internal reflection. The critical angle θ_{c} is defined by the refractive index of the polymer, n₂, and the refractive index of any material next to the polymer structure, n₁, i.e. according to Snells Law, sin θ_{c}=n₁/n₂, where n₁<n₂.

In order to obtain total internal reflection at no more than n-1 sidewalls, the angles between the sidewalls may be carefully selected so that an electromagnetic wave incident on e.g. n-1 sidewalls experiences total internal reflection, whereas the angle of incidence on at least the n^{th} sidewall allows for coupling an output electromagnetic wave out of the structure. This may be achieved for example by a shape being polygonal, such as triangular or trapezoidal.

Hereby, any material allowing for total internal reflection inside the structure may surround the structure. This material may be air or any other suitable material, such as a polymer or a liquid, having a refractive index smaller than the refractive index of the radiation sensitive polymer and corresponding to the selected shape.

Alternatively, total internal reflection may be obtained by providing at least one material at least along a part of at least one sidewall of the structure. The at least one material may for example comprise a first and a second material e.g. selected so that a first material is provided along a first number of sidewalls and a second material is provided along a second number of sidewalls, the materials and the angles between the sidewalls being selected so as to provide total internal reflection due to an incident angle being greater than the critical angle for a propagating electromagnetic wave incident on the first number of sidewalls, whereas the second material is selected so that the propagating electromagnetic wave incident on the second number of sidewalls are incident under an angle being less than the critical angle, so as to allow for outputting an electromagnetic wave through the second number of sidewalls.

In a preferred embodiment, the electromagnetic wave is emitted parallel to the substrate, so that the electromagnetic wave may be emitted laterally.

In another preferred embodiment, the electromagnetic wave is emitted at the Brewster angle, whereby a polarisation dependent resonator cavity may be provided.

The first material may be any material having a refractive index lower than the refractive index of the polymer. The material may thus be air, liquids, polymers, plastics, or ceramics, insulators, etc.

The second material having a refractive index different from the refractive index of the first material may be air, liquids, polymers, plastics, or ceramics, etc. in a preferred embodiment, the second material is a material capable of guiding electromagnetic waves, such as a polymer, such as SU-8, such as a glass waveguide, etc. The waveguides may be provided on the substrate after the resonator cavity has been formed or, alternatively, the waveguides may be formed in any pre-patterned structures by the use of any material platform before the resonator cavity is formed.

The second material may be provided along at least a part of at least one sidewall for allowing for emission of an electromagnetic wave from the structure. In a preferred embodiment the shape of the structure is rectangular and the critical angle of the at least part of the at least one sidewall may be altered due to the presence of the second material for outputting an electromagnetic wave.

According to a further aspect of the invention, an optical device for providing optical amplification is provided wherein the device comprises

a substrate,

a photo-definable polymer structure provided on the substrate in a predetermined shape and being doped with an optically active medium.

In the present context a photo-definable is to be interpreted as a polymer which is sensitive to electromagnetic radiation having a wavelength above 250 nm so that standard exposure systems may be used.

The photo-definable polymer may thus be photo-definable by a source of electromagnetic energy having a wavelength larger than 250 nm, such as larger than 260, such as larger than 270, such as larger than 275 nm, such as larger than 280 nm, such as larger than 300 nm, such as about 365 nm, larger than 400 nm, such as about 485 nm.

According to a still further aspect of the invention an optical device for providing optical amplification is provided, the device comprises

a substrate,

a photo-definable polymer structure provided on the substrate in a predetermined shape and being doped with an optically active medium,

wherein the photo-definable polymer is a negative tone photo-definable polymer.

According to a still further aspect of the present invention an optical device for providing optical amplification upon pumping is provided, the device comprises

a substrate,

a photo-definable polymer structure provided on the substrate in a predetermined shape and being doped with an optically active medium,

wherein the photo-definable polymer is an epoxy based photo-definable polymer.

It is an advantage to use an epoxy based photo-definable polymer since the epoxy based polymer is very stable as soon as cross-linking has been effected. The epoxy based polymer thus has a high resistivity against chemical and mechanical impacts.

The optically active medium may require pumping to achieve any optical amplification. The optically active medium may require electrical or, preferably, optical pumping.

Preferably, the optically active medium is pumped by a pulsed pumping source, such as a pulsed laser. It is preferred to use short pulse widths, especially when pumping a laser dye. By using short pulse widths, such as pulse widths below 10 μs, such as below 100 ns, preferably such as about 5 ns. The repetition rate is preferably selected to be below 100 Hz, such as about 10 Hz. It is an advantage of using short pulse width that substantially no heating of the device takes place. Furthermore, when using a laser dye as optically active medium, it is an advantage that no triplets are formed when the pulse width is kept at least below 10 μs.

The polymer structure may form a cavity resonator, for example being defined by sidewalls of the structure, and depending on the optically active medium and the potential of this medium to provide for e.g. population inversion, etc., the cavity resonator may be a laser cavity. Furthermore, dependent on the optically active medium and the amount of pumping of the cavity resonator, the emitted electromagnetic wave may be a coherent electromagnetic wave.

The geometry of the cavity resonator alters the mode of the spectrum of the emitted light and the optical path length in the resonator cavity defines the output wavelength. It is seen that in one embodiment of the invention, the length of the cavity, preferably the optical path length in the resonator cavity, may be in the order of the wavelength of the propagating electromagnetic wave, thereby allowing for emission of a coherent electromagnetic wave being a single mode electromagnetic wave.

The wavelength of the output electromagnetic wave may be determined as a function of concentration of the optically active medium in the polymer and resonator cavity length and furthermore dependent on the optically active medium used.

The radiation sensitive polymer is definable by photo lithography, e-beam lithography, X-ray lithography, ion-beam lithography, or hot embossing or nano imprinting lithographies. Preferably, the radiation sensitive polymer is definable by photo-lithography so that standard optical lithography using i-line lithography (i.e. an exposing light beam at a wavelength of about 365 nm) may be used. The integration with further elements on a chip system may thus be easily accomplished.

The device may further comprises an array of cavity resonators, the cavity resonators being coupled or non-coupled, the coupling may e.g. be due to the coupling of evanescent field of neighbouring cavities. The array may comprise periodically distributed cavity resonators, so that e.g. a grating may be provided. Still further, the device may comprise coupled cavity resonators.

The shape of the structure may be circular or elliptical, however in a preferred embodiment the shape is a polygon, such as for example a trapezoid or a triangle. If the shape e.g. is trapezoid, the electromagnetic wave propagating in the cavity may be incident at an angle greater than the critical angle at three sidewalls of the trapezoid, whereas the angle of incidence on the fourth sidewall is less than the critical angle so as to allow for coupling an output wave out of the cavity resonator.

The polymer is preferably a solid polymer. The radiation sensitive polymer may be a negative tone resist, whereby the unexposed part of the polymer are removed during development of the structure. However, in some embodiments it may be advantageous to use a positive resist so that exposing of the active areas are not necessary, whereby any exposure of, and thus any potential damage, to the optically active medium is avoided.

To obtain a structure being chemically stable, an epoxy based radiation sensitive polymer, may be used. During exposure, and typically also a post exposure bake step, the epoxy based polymer is cross-linked and very strong bonds are formed in the epoxy based polymer making the structure suitable for fabrication of many kinds of structures.

It is preferred that the radiation sensitive polymer is photo-definable, preferably by an electromagnetic source having a wavelength above 250 nm, such as above 280 nm, such as above 300 nm, such as above 320 nm, such as above 350 nm, preferably about 365 nm, used in i-line lithography, such as above 400 nm, such as above 430 nm, preferably such as about 436 nm (used in g-line lithography).

It is an advantage of being able to use standard photo lithography using near UV radiation (350-450 nm) that the integration with any other devices on a chip is much less complicated when standard manufacturing methods may be used. It reduces the complexity of the fabrication process and thus further reduces the cost of the final sample. And since the costs of e.g. single use samples need to be reduced in order to allow for widespread use of such single use devices, reduction of the manufacturing costs are an essential need for the continued growth of the market for such devices.

In a preferred embodiment, the polymer has a low absorption so as to allow for definition of a structure in the polymer with out the use of high doses of polymer. It is a further advantage of the polymer having a low absorption that the propagating electromagnetic wave is not absorbed due to e.g. propagation losses in the structure.

The polymer may preferably be SU-8 being a resist having high aspect ratio imaging and having a good chemically and thermally resistance.

The optically active medium may comprise organic compounds, such as laser dyes, rare earth's, such as Erbium, nano-particles, quantum dots, etc.,

In a preferred embodiment the wavelength range in which absorption occurs is only to a certain extent overlapping the wavelength range in which the optically active medium is active.

In an especially preferred embodiment, the optically active medium is a dye, such as a laser dye, such as Rhodamine, Couramine, etc., etc. By optically pumping the device wherein the polymer comprises a laser dye, pumping light is absorbed by the dye and fluorescence is emitted. The wavelength of the emitted light depends on the geometry of the resonator cavity, the polymer and the concentration of the dye, and the wavelength of the emitted light may thus be tuned by tuning e.g. the optical path length of the laser cavity. It is preferred that the maximum absorption of the laser dye is at a wavelength different from the emission wavelength range.

In a preferred embodiment, the pumping light beam is incident substantially orthogonal to the surface of the structure.

In one embodiment of the invention the laser dye is Rhodamine, such as Rhodamine 6G Chloride, such as Rhodamine 6G R 4127, such as the dye having Cas No. 989-38-8.

The concentration of the dye need to be sufficiently high so as to reach the threshold for the gain condition, i.e. for population inversion and thus for lasing. However, the concentration should be kept so low so that substantially no dimers are formed, since the dimers, e.g. for Rhodamine, have a high absorption in the wavelength range where Rhodamine is emitting light, the absorption being in the same order of magnitude as the emission. For Rhodamine, gain is obtained from about 560 nm to 620 nm. For other laser dyes gain is obtained in a different wavelength range, and typically, laser dyes will experience gain in the wavelength range from e.g. 300 nm-1000 nm, such as from 400 nm-800 nm, such as from 500-650 nm, and furthermore gain may be obtained at wavelengths above 400 nm, such as above 500 nm, such as above 550 nm.

Preferably, the dye concentration in the polymer is above 0.8 μmole/cm³, such as above 1.1 μmole/cm³, such as above 1.3 μmole/cm³, such as above 3.5 μmole/cm³. The dye concentration in the polymer may be between 0.7 μmole/cm³ and 10 μmole/cm³, such as between 0.8 μmole/cm³ and 5 μmole/cm³, such as between 1.1 μmole/cm³ and 3.5 μmole/cm³. It is envisaged that the preferred dye concentrations in the polymers depends on the dye as well as the polymer. It is preferred that the dye concentration is high enough so that the lasing threshold may be reached but the concentration should on the other hand not be so high so that an excessive number of dimers are formed. The polymer may further be a modified polymer, such as a dendrimer, so that the dye concentration may be increased.

The substrate may be any substrate, such as a metal substrate, a semiconductor substrate, a ceramic substrate, a glass substrate, such as a Pyrex substrate or any combination of such materials. The refractive index of the substrate has preferably a refractive index being less than the refractive index of the polymer. Alternatively, an additional layer may be provided between the polymer and the substrate. The additional layer may either be a layer reducing the absorbance of the substrate or the additional layer may be a layer improving the adhesion between the polymer and the substrate, i.e. the additional layer.

The polymer structure may have a height of less than 2 mm, such as less than 1 mm, such as less than 500 μm, such as less than 300 μm, such as less than 100 μm, such as less than 10 μm, such as less than 2 μm, preferably having a height between 0,5 μm and 10 μm, such as between 1 μm and 5 μm.

The length of the cavity may be any length supporting amplification in the cavity, thus the length of the cavity may range from submicron to a couple of millimetres.

Furthermore, a method of manufacturing an optically active medium is provided, the method comprising the steps of:

providing a substrate,

providing a radiation sensitive polymer being doped with an optically active medium on the substrate,

defining a predetermined structure in the radiation sensitive polymer by lithography.

The step of providing the radiation sensitive polymer on the substrate may comprise the step of spin-coating the substrate with the radiation sensitive polymer being doped with an optically active medium.

Furthermore, the step of defining the structure may comprise the steps of exposing the spin-coated polymer in a predetermined pattern, and developing the predetermined pattern to form at least one polymer structure.

Still further, the step of defining the structure may further comprise the step of soft-baking the polymer prior to the exposing step. For some polymer materials, it is preferred that the step of defining the structure further comprises the step of post exposure baking the polymer, i.e. baking the polymer after the exposing step.

The step of developing may comprise the step of using a wet developer for developing the pattern.

In a preferred embodiment the optically active medium is soluted in the polymer prior to providing the polymer to the substrate. This ensures a homogeneous distribution of the optically active medium in the polymer structure.

According to a still further aspect of the invention a method for laterally emitting an electromagnetic wave is provided, the method comprises the steps of

providing a radiation sensitive polymer being doped with an optically active medium on a substrate,

defining a structure in the polymer by exposing the polymer to radiation in a predetermined pattern,

developing the predetermined pattern to obtain at least one structure in the polymer,

pumping the structure by a pump source so as to provide activation of the optically active medium,

laterally emitting an electromagnetic wave.

Still further, a micro system comprising at least one optical device according to any of the above described devices is provided.

The micro system may further comprise at least one waveguide channel and in a preferred embodiment the at least one waveguide channel and the polymer structure of the optical device is fabricated in the same polymer material. It is further preferred to provide the polymer structure so that an output of the polymer structure is coupled directly into the polymer waveguide channel.

### BRIEF DESCRIPTION OF THE DRAWINGS

FIG. 1 shows absorption and emission spectra of a specific laser dye, Rhodamine 6G,

FIG. 2 shows a triangular design of a resonator cavity according to an embodiment of the present invention,

FIG. 3 shows a trapezoid design of a resonator cavity according to an embodiment of the present invention,

FIG. 4a is a SEM photo of a trapezoid laser,

FIG. 4b shows measured angular distribution of laser emission from the trapezoid laser of FIG. 4a,

FIG. 5 is a SEM photo of a triangular laser design,

FIG. 6 shows an emission spectra measured from an array of laterally emitting triangular shaped lasers,

FIG. 7 shows an emission spectra from a laterally emitting trapezoid laser,

FIG. 8 shows a measured peak wavelength as a function of laser dye concentration.

FIG. 9 shows an alternative design of a trapezoid shaped polymer structure.

### DETAILED DESCRIPTION OF THE DRAWINGS

In the detailed description a preferred embodiment of a new type of optically pumped solid polymer dye lasers according to the present invention are discussed, which can easily be integrated with polymer based microsystems. The solid state lasers are realized by doping a photo-definable polymer, SU-8, with a commercially available laser dye, Rhodamine 6G. This approach allows for fabricating miniaturized solid polymer dye lasers on any suitable substrate, by applying standard UV lithography to the dye doped photo definable polymer. By using photolithography, a large degree of freedom in design is achieved. Another attractive feature is the simple design, where total internal reflections on the vertical polymer cavity sidewalls are exploited. It is however envisaged that similar results may be obtained by many other combinations of polymers and optically active media.

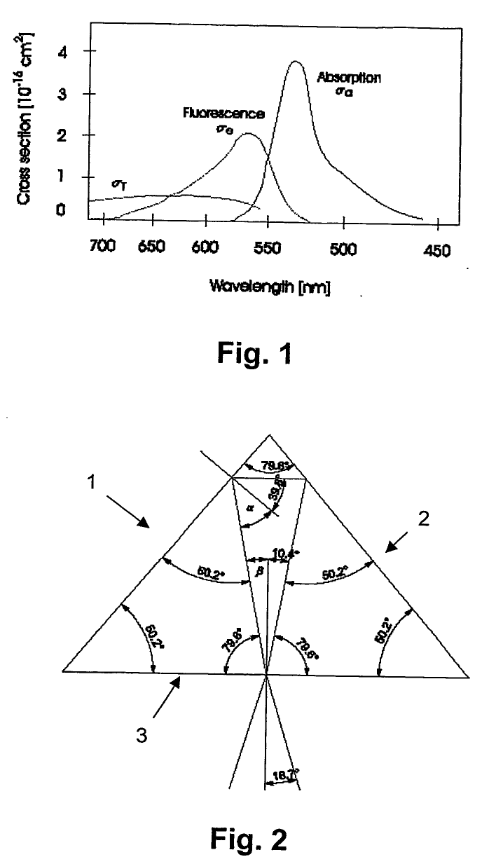

The optically active medium is in a preferred embodiment a laser dye and in FIG. 1, the absorption and emission spectra of the specific laser dye, Rhodamine 6G, is shown for illustration of the principle of dye lasers. The absorption and the fluorescence resulting from transitions between the ground state and the first singlet state is shown together with the triplet-triplet absorption. As a function of increasing energy, equivalent to decreasing wavelength, the absorption curve has a sharp rising edge and a slower tail characteristic of excitation from a ground state to a quasicontinuum of states.

The laser dye is optically pumped by a pulsed, frequency doubled Nd:YAG laser at a wavelength of 532 nm, being close to the peak of maximum absorption for Rhodamine 6G. It is seen that the laser dye Rhodamine 6G has optical gain in the wavelength range from approx. 550 nm to 620 nm., i.e. the wavelength range in which the fluorescence cross-section σₑ is larger than the absorption cross-section σₐ. Thus, gain occurs under the fluorescence curve but is reduced in the region which overlaps with the absorption. σₐ is the absorption cross-section for the S0→Si transition, and σₑ is the emission cross section. Moreover, the triplet absorption cross section for the T1→T2 transition is σ_{T}.

The pulse width of the laser is about 5 ns with a repetition rate of 10 Hz. The power ranges from 0.5 mW-50 mW.

In FIG. 2 a triangular shaped cavity resonator having total internal reflection at two of the three sidewalls is shown. The cavity resonator thus contains a self intersecting mode such that total internal reflection is obtained on two sides. The angle of incidence on two of the sidewalls 1, 2 exceed the critical angle, thus the reflection from the sidewalls are 100%. At the output interface, the sidewall 3, a reflection of 5.2% is obtained for a cavity resonator in SU-8 polymer doped with Rhodamine and the cavity being surrounded by air. The output angle is 16.7°. The bottom left and right angles are 50.2° and the top angle is 79.6°.

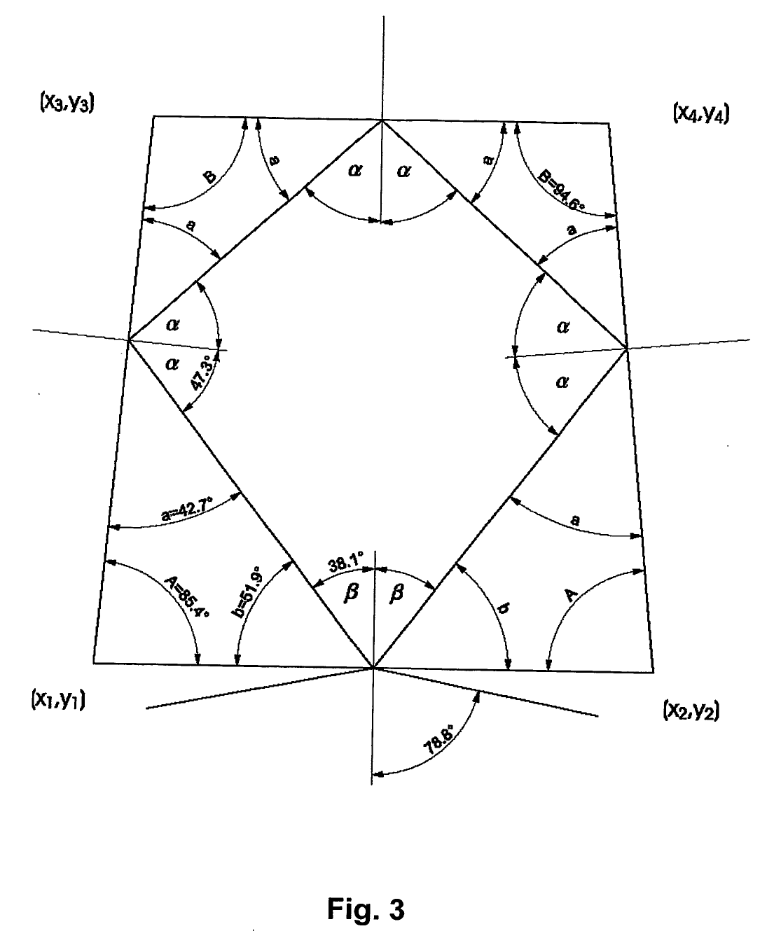

In FIG. 3 a trapezoid shaped cavity resonator being a laser cavity in SU-8 polymer doped with Rhodamine and being surrounded by air, is shown wherein total internal reflection is obtained at three sidewalls of the structure 5, 6, 7. The angle of incidence on three of the four sidewalls 5, 6, 7, exceeds the critical angle, thus the reflection from these sidewalls are 100%. At the output interface, a reflection of 36.4% is obtained. Thus, for the trapezoid shape it has been possible to obtain an increased reflection from the sidewall 8 through which the laser beam is coupled out. The output angle is 78.8°.

The critical angle for the SU-8/air interface is θc=38.97°(n_{SU-8}=1.59). In the triangular design the desired cavity mode is reflected three times per round trip. The geometry allows for an angle of incidence above the critical angle, θc, at two of the reflection points. The angle of incidence at the third reflection point, where the output coupling takes place, is then restricted to be less than 10 degrees, resulting in a reflectance of approx. 5 percent in this point. The desired cavity mode in the trapezoid shaped cavity is reflected four times per round trip. This design allows for an angle of incidence, α=47.29°, above θc at three reflection points, and an angle, β=38.14°, close to but below the θc at the fourth reflection point. This allows for a design with a reflectance of about 37 percent at the output coupling. It is difficult to obtain much higher values of reflectance at the output coupling, without exceeding the critical angle due to the steep increase in reflectance as the critical angle is approached.

For fabrication of the laser cavities, the Rhodamine 6G (Sigma-Aldric, R4127) is dissolved into SU-8 thinner, which is mixed into the SU-8 10 μm photo-resist, both from MicroChem. The SU-8 based micro laser cavities can then be defined on any suitable substrate using the standard photo-lithographic process steps: spin-coating, soft-baking, i-line UV exposure, post-exposure baking, and development. The structures are fabricated on a glass Pyrex substrate and the height is 4.2 μm.

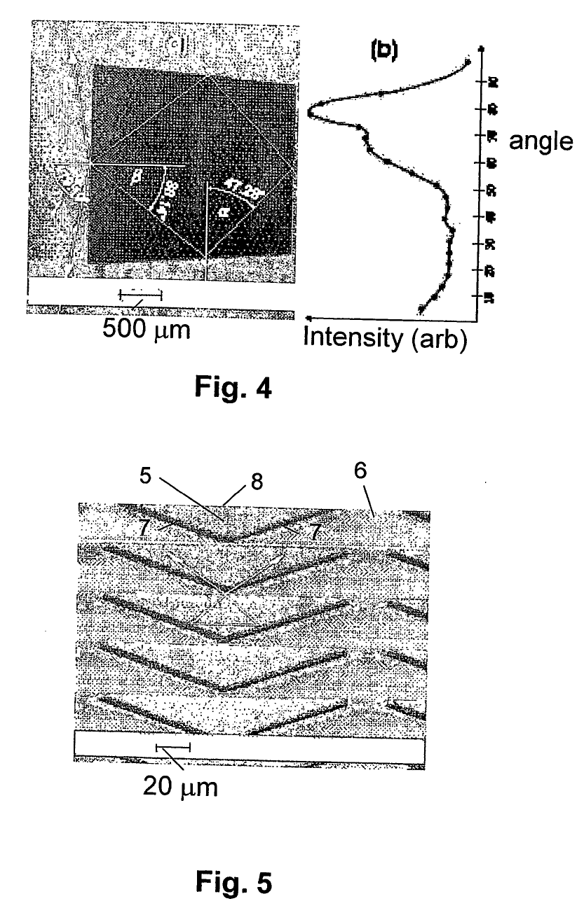

In FIG. 4a a SEM photo shows the geometry of the trapezoid laser. There is total internal reflection on three of the sides and a reflectance of 37% at the fourth side where the output coupling is placed. The critical angle of the SU-8/air interface is θc=38.97°. In FIG. 4b , measured angular distribution of laser emission from the trapezoid laser is shown (intensity vs. angle). The angle α is 47.29°, the angle β is 38.14° and the angle γ is 79.10°.

FIG. 5 shows a SEM photo of the triangular laser design. The round trip is superimposed and is 190 μm long. The reflectance at the output interface is approximately 5%. It is seen that the polymer structure 5 is provided on a Si-substrate 6, and has n sidewalls 7, 8. The triangular polymer structure in FIG. 5 thus has 3 sidewalls and from one of these, the sidewall 5, an electromagnetic wave is emitted.

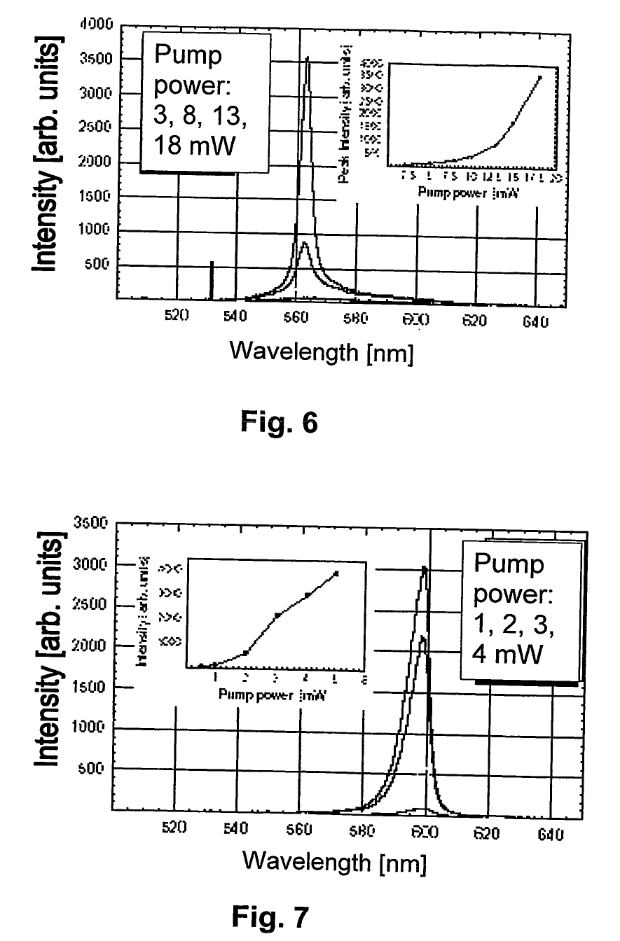

The lasers are optically pumped by a pulsed, frequency doubled Nd:YAG laser, and the emitted light is collected by an optical fiber connected to a spectrometer. FIG. 6 shows a series of emission spectra from an array of laterally emitting triangular shaped lasers, measured at different levels of pumping power, the levels being 3 mW, 8 mW, 13 mW and 18 mW of pumping power. The laser peak is established at 562 nm and the peak at 532 nm is scattered light from the Nd:YAG pump laser. FIG. 7 shows a similar set of spectra from the trapezoid shaped device, measured at different levels of pumping power, the levels being 1 mW, 2 mW, 3 mW and 4 mW, where the peak appears at a wavelength of 598 nm and is measured in the plane of the laser at an angle γ=7920 . According to the design, the triangle and trapezoid lasers should emit at an angle of 17 degrees and 79 degrees, respectively.

It is thus seen from the two emission spectra, in FIGS. 6 and 7 that it is possible to vary the peak wavelength more than 30 nm by change of the lateral design only.

In the inserts in FIGS. 6 and 7, the intensity of the output beam is shown as a function of the pumping power.

Furthermore, it is envisaged that by utilizing the good planarization properties of SU-8, a laterally emitting dye laser may be integrated with a SU-8 waveguide. The integrated optical system is realized by two successive UV lithography steps, defining the laser in dye doped SU-8 and the waveguide in normal SU-8. This makes the polymer laser very attractive for the development of lab-on-a-chip micro systems.

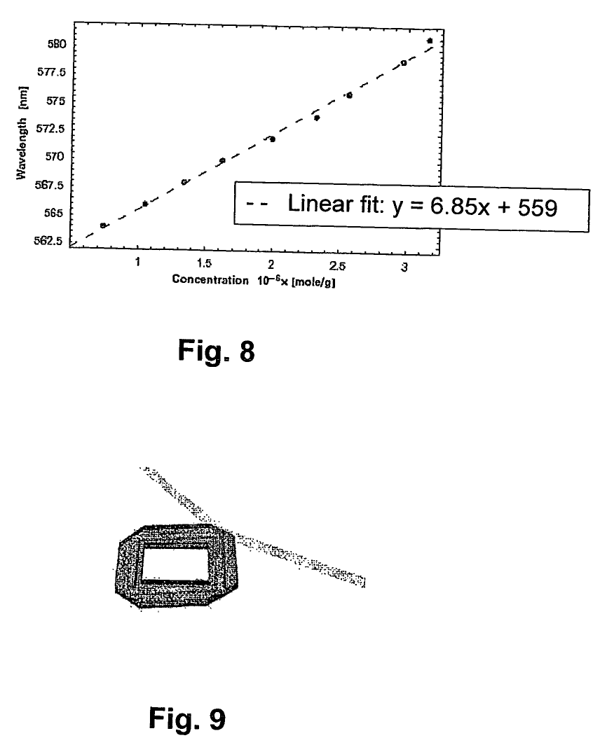

In FIG. 8, the measured peak wavelength for a 4.8 μm SU-8 film on a gold/silicon substrate is mapped as a function of the concentration.

There is a minimum fraction of dye molecules that must be raised to the first singlet state to reach the threshold of oscillation. This minimum is a function of the cross sections of fluorescence and absorption, and cavity determined parameters. The frequency at which the laser will begin to oscillate is determined from the minimum of the oscillation condition.

The oscillation frequency will decrease as N increases, which is the equivalent of saying that the wavelength will increase as the concentration is increased. This relation is experimentally observed as the peak wavelength is measured as a function of the Rhodamine 6G concentration in a 4.8 μm thick SU-8 film. The correlation between the Rhodamine 6G concentration and the peak wavelength is presented in Table 1 and graphically in FIG. 8. Although the cross sections σₐ and σ_{f} are not known there is a qualitative agreement between the observed and theoretical relation. As indicated in Table 1, the peak wavelength assumes values in a range of 17 nm, which is achieved by only changing the concentration of Rhodamine 6G, thus making the dye laser a versatile instrument.

| | | | | | | | | | |
|---|---|---|---|---|---|---|---|---|---|
| Peak | 564 | 566 | 568 | 570 | 572 | 574 | 576 | 579 | 581 |
| wavelength | | | | | | | | | |
| (nm) | | | | | | | | | |
| Concentration | 0.741 | 1.05 | 1.34 | 1.62 | 1.99 | 2.32 | 2.56 | 2.96 | 3.15 |
| [mole/g]*10⁻⁶ | | | | | | | | | |

A less mathematical picture may be employed in explaining the lasing wavelength as the dye concentration is varied. Below the lasing threshold the population is not inverted and the absorption is dominating. As the pumping power is increased the net gain increases, and the net gain maximum moves towards lower wavelengths. At some point the threshold condition is fulfilled—namely, the gain must exceed the losses, and these may be expressed by the cavity losses 1-R. Hence, the lasing wavelength will increase when the dye concentration increases since the net gain increases more rapidly, and the losses are exceeded at a longer wavelength. During the measurements of the peak wavelength as a function of the Rhodamine 6G concentration, optical bleaching is observed—especially at lower concentrations since such samples require a higher pumping intensity.

As expected the lasing wavelength decreases since some of the Rhodamine 6G dye molecules are destroyed and the concentration decreases. The model describing the lasing wavelength as the intersection between the gain maximum and the curve representing the losses, readily explains the relation between cavity length and peak wavelength.

In Table 2, the lasing wavelength for the three trapezoid shaped lasers with different cavity lengths and one triangular shaped laser is stated. The longer the cavity length is, the longer is the lasing wavelength. This is simply due to the higher gain in a long cavity compared to a shorter one when the losses are constant. In the triangular shaped laser, which has a cavity length of d=95 μm, the lasing wavelength is observed at 564 nm which is equal to the lasing wavelength of the trapezoid shaped laser having a shorter cavity length of d=54.5 μm. This is explained by the higher losses in the triangular design compared to the trapezoid shaped design—when the losses are increased, the gain maximum and the cavity losses intersect at a lower wavelength.

| | | | | |
|---|---|---|---|---|
| cavity length, | 54.5 | 135 | 2032 | 95 |
| d [μm] | | | | (triangular |
| | | | | shaped) |
| Lasing | 564 | 573 | 598 | 564 |
| wavelength | | | | |
| [nm] | | | | |

It is thus seen from Tables 1 and 2 and FIG. 8, that the lasing wavelength of a laser cavity may be tuned by selecting dye concentration and cavity length. Even though the principle is here described by using a Rhodamine doped SU-8 polymer, the principle applies to most dye lasers.

By using this feature, it is possible to provide an array of lasers according to the present invention on a single chip so that lasers having lasing wavelengths in a wide wavelength range may be provided on this chip.

In FIG. 9, an alternative embodiment of a resonator cavity is shown. The trapezoid corresponds to the trapezoids describe above only parts (center part and edge parts) of the original shape are cut out. Hereby, a cavity allowing only one plane wave trajectory in the cavity are provided.

It is envisaged that many other forms and shapes may be provided to obtain propagation of specific modes, etc. using the principle of total internal reflection on all but one sidewall of the cavity.

1. An optical device for providing optical amplification, comprising:
a substrate; and
a photo-definable polymer structure formed on the substrate in a shape defined by a number of sidewalls, n, and being doped with an optically active medium, wherein the sidewalls of the structure form a cavity resonator so that an electromagnetic wave is emitted laterally upon pumping of the device.

2. An optical device according to claim 1, wherein the shape and/or at least one material provided at least along a part of at least one sidewall of the structure are selected so that the electromagnetic wave propagating in the structure will experience total internal reflection when incident on no more than n-1 sidewalls.

3. An optical device according to claim 1, wherein the electromagnetic wave propagating in the structure is incident at the no more than n-1 sidewalls at an angle greater than a critical angle.

4. An optical device according to claim 1, wherein total internal reflection is obtained by providing the first material along a first number of sidewalls and providing a second material along a second number of sidewalls, the first and second materials and the angles between the sidewalls being selected so as to provide total internal reflection due to an incident angle of a propagating electromagnetic wave being greater than the critical angle for a propagating electromagnetic wave incident on the first number of sidewalls, whereas the second material is selected so that the propagating electromagnetic wave incident on the second number of sidewalls are incident under an angle being less than the critical angle, so as to allow for outputting an electromagnetic wave from the second number of sidewalls.

5. An optical device according to claim 1, wherein a second material is provided along at least a part of at least one sidewall for allowing for emission of an electromagnetic wave from the structure, wherein the shape is rectangular, and wherein the critical angle of the at least part of the at least one sidewall is altered due to the presence of the second material.

6. An optical device according to claim 1, wherein the emitted or the propagating electromagnetic wave is a single mode electromagnetic wave.

7. (canceled)

8. An optical device according to claim 1, wherein the length of the cavity resonator is on the order of the wavelength of the emitted or the propagating electromagnetic wave.

9. An optical device according to claim 1, wherein the wavelength of the emitted electromagnetic wave is determined as a function of concentration of optically active medium in the polymer and resonator cavity length.

10. An optical device according to claim 1, wherein the photo-definable polymer is definable by photolithography.

11. An optical device according to claim 1, wherein the device comprises an array of cavity resonators.

12. An optical device according to claim 11, wherein at least two cavity resonators in the array are coupled.

13. An optical device according to claim 1, wherein the shape is circular or elliptical.

14. An optical device according to claim 1, wherein the photo-definable polymer is a negative tone resist.

15. An optical device according to claim 1, wherein the photo-definable polymer is epoxy based.

16. An optical device according to claim 1, wherein the polymer is photo-definable by an electromagnetic source having a wavelength above 250 nm.

17. An optical device according to claim 1, wherein the polymer is photo-definable by an electromagnetic source having a wavelength of about 370 nm (i-line).

18. An optical device according to claim 1, wherein the optically active medium comprises organic compounds, rare earths nanoparticles, or quantum dots.

19. An optical device according to claim 1, wherein the optically active medium is a dye with a concentration in the polymer above 1.1 μmole/cm³.

20. An optical device according to claim 1, wherein the substrate is a metal substrate, a semiconductor substrate, a ceramic substrate, a glass substrate, or any combination thereof.

21. An optical device according to claim 1, wherein the structure has a height above 2 μm.

22. An optical device for providing optical amplification, comprising:
a substrate; and
a photo-definable polymer structure formed on the substrate in a shape defining a cavity resonator and being doped with an optically active medium.

23. An optical device according to claim 1 or 22, wherein the photo-definable polymer is SU-8.

24. A method of manufacturing an optically active medium, the method comprising the steps of:
providing a substrate;
providing a photo-definable polymer doped with an optically active medium on the substrate; and
defining a shape of a cavity resonator in the photo-definable polymer by photolithography.

25. A method according to claim 24, wherein the step of providing the photo-definable polymer on the substrate comprises the step of spin-coating the substrate with the photo-definable polymer being doped with an optically active medium.

26. A method according to claim 25, wherein the step of defining the structure comprises the steps of:
exposing the spin-coated polymer in a predetermined pattern; and
developing the predetermined pattern to form at least one polymer structure.

27. A method according to claim 26, wherein the step of defining the structure further comprises the step of soft-baking the polymer prior to the exposing step.

28. A method according to claim 26, wherein the step of defining the structure further comprises the step of post exposure baking the polymer after the exposing step.

29. A method according to claim 26, wherein the step of developing comprises the step of using a wet developer for developing the pattern.

30. A method for laterally emitting an electromagnetic wave, comprising the steps of:
providing a photo-definable polymer doped with an optically active medium on a substrate;
defining a shape of a cavity resonator in the polymer by exposing the polymer to optical radiation;
developing the exposed polymer to obtain at least one structure in the polymer;
pumping the structure by a pump source so as to provide activation of the optically active medium; and
laterally emitting an electromagnetic wave.

31. A micro system comprising at least one optical device according to claim 1 or 22.

32. A micro system according to claim 31, further comprising at least one waveguide channel.

33. A micro system according to claim 32, wherein the at least one waveguide channel and the polymer structure of the optical device is fabricated from the same polymer material.

34. A micro system according to claim 32, wherein the polymer structure is provided so that an output of the polymer structure is coupled directly into the polymer waveguide channel.

35. The optical device according to claim 18, wherein said rare earth is erbium.

36. The optical device according to claim 20, wherein said glass substrate is a Pyrex substrate.
